(19) United States
(12) Patent Application Publication
(10) Pub. No.: US 2011/0205606 A1
(43) Pub. Date: Aug. 25, 2011

(54) EXPOSING DEVICE AND IMAGE FORMING APPARATUS

(75) Inventors: Jiro MINABE, Kanagawa (JP); Yasuhiro OGASAWARA, Kanagawa (JP); Keishi SHIMIZU, Kanagawa (JP)

(73) Assignee: FUJI XEROX CO., LTD., Tokyo (JP)

(21) Appl. No.: 12/859,488

(22) Filed: Aug. 19, 2010

(30) Foreign Application Priority Data
Feb. 24, 2010 (JP) 2010-039345

(51) Int. Cl. G03H 1/20

(52) U.S. Cl. 359/12

(57) ABSTRACT

There is provided an exposing device including: a light emitting element array of plural light emitting elements arrayed in a row with a first separation along a predetermined direction; and a hologram element array in which plural hologram elements are multiplex recorded in a recording layer disposed above the light emitting element array, the plural hologram elements corresponding to each of the plural light emitting elements such that diffracted beams of light emitted from the plural light emitting elements are converged to form focused beam spots in a row along the predetermined direction with a second separation smaller than the first separation at an surface to be exposed.

### CROSS-REFERENCE TO RELATED APPLICATION

This application is based on and claims priority under 35 USC 119 from Japanese Patent Application No. 2010-039345 filed on Feb. 24, 2010.

### BACKGROUND

### Technical Field

The present invention relates to an exposing device and an image forming apparatus.

### SUMMARY

According to an aspect of the invention, there is provided an exposing device including:

a light emitting element array of plural light emitting elements arrayed in a row with a first separation along a predetermined direction; and

a hologram element array in which plural hologram elements are multiplex recorded in a recording layer disposed above the light emitting element array, the plural hologram elements corresponding to each of the plural light emitting elements such that diffracted beams of light emitted from the plural light emitting elements are converged to form focused beam spots in a row along the predetermined direction with a second separation smaller than the first separation at an surface to be exposed.

### BRIEF DESCRIPTION OF THE DRAWINGS

Exemplary embodiments of the present invention will be described in detail based on the following figures, wherein:

FIG. 1 is a schematic diagram showing an example of a configuration of an image forming apparatus according to an exemplary embodiment of the present invention;

FIG. 2 is a schematic perspective view showing an example of an LED print head according to an exemplary embodiment of the present invention;

FIG. 3A is a perspective view showing a schematic shape of a hologram element;

FIG. 3B is a cross-section taken along the slow scanning direction of an LED print head;

FIG. 3C is a cross-section taken along the fast scanning direction of an LED print head;

FIG. 4 is diagram showing an element in which a hologram is recorded in a hologram recording layer;

FIG. 5A and FIG. 5B are diagrams showing an element in which a hologram is illuminated, generating a diffracted beam;

FIG. 6 is a diagram showing an element in which the LED pitch is greater than the spot pitch;

FIG. 7 is a diagram showing elements with regeneration in a case where the LED pitch and the LED diameter are both greater than the spot pitch;

FIG. 8 is a diagram showing elements with regeneration in a case where the LED pitch is greater than the spot pitch, and the LED diameter is greater than the spot diameter; and

FIG. 9 is a partial perspective view showing an example of a partial configuration of an LED print head formed with a hologram element array corresponding to a SLED array.

### DETAILED DESCRIPTION

A detailed explanation follows of an exemplary embodiment of the present invention, with reference to the drawings.

Image Forming Apparatus Installed with LED Print Head

First, explanation follows regarding an image forming apparatus installed with an LED print head according to an exemplary embodiment of the present invention. In, for example, copying machines, printers, and the like, that form images by electrophotographic methods, Light Emitting Diode (LED) exposing devices, employing LEDs as light sources, are becoming prevalent as exposing devices for writing a latent image onto a photoreceptor drum, in place of conventional laser Raster Output Scanner (ROS) exposing devices. In LED exposing devices, a scanning optical system is not required, enabling much greater compactness in comparison to laser ROS exposing devices. LED exposing devices are also advantageous in not requiring a drive motor for driving a polygon mirror, and not generating mechanical noise.

LED exposing devices are referred to as LED print heads, abbreviated to LPH. Conventional LED print heads are provided with an LED array of large number of LEDs arrayed on art elongated substrate, and a lens array disposed with a large number of gradient index rod lenses. In the LED array, there are a large number of LEDs, corresponding to the number of pixels arrayed along the fast scanning direction, for example 1200 pixels per inch (namely 1200 dpi). Conventionally, rod lenses are employed in a lens array, such as, for example, SELFOC (registered trademark) lenses or the like. Light emitted from each of the LEDs is converged by the rod lens, and a right side up, same size image is formed on a photoreceptor drum.

LED print heads in which “hologram elements” are employed in place of rod lenses are being investigated. The image forming apparatus according to the present exemplary embodiment is equipped with an LED print head provided with “a hologram element array”, as described below. In an LPH in which rod lenses are employed, the optical path length (operating distance) from the end face of the lens array to the imaging point is short, of the order of a few mm, and the proportion of the periphery of the photoreceptor drum occupied by the exposing device is large. In contrast thereto, in an LPH 14 provided with a hologram element array, the operating distance is long, of the order of a few cm, the periphery of the photoreceptor drum is not crowded, and as a whole, the image forming apparatus is made more compact.

Generally, in an LPH employing LEDs emitting incoherent light, as the coherency reduces, blurred spots (referred to as chromatic aberration) occurs, and it is not easy to form very small diameter spots. In contrast thereto, in the LPH 14 provided with the hologram element array, the incident angle selectivity and wavelength selectivity of the hologram elements is high, and sharp outlined very small diameter spots are formable on a photoreceptor drum 12.

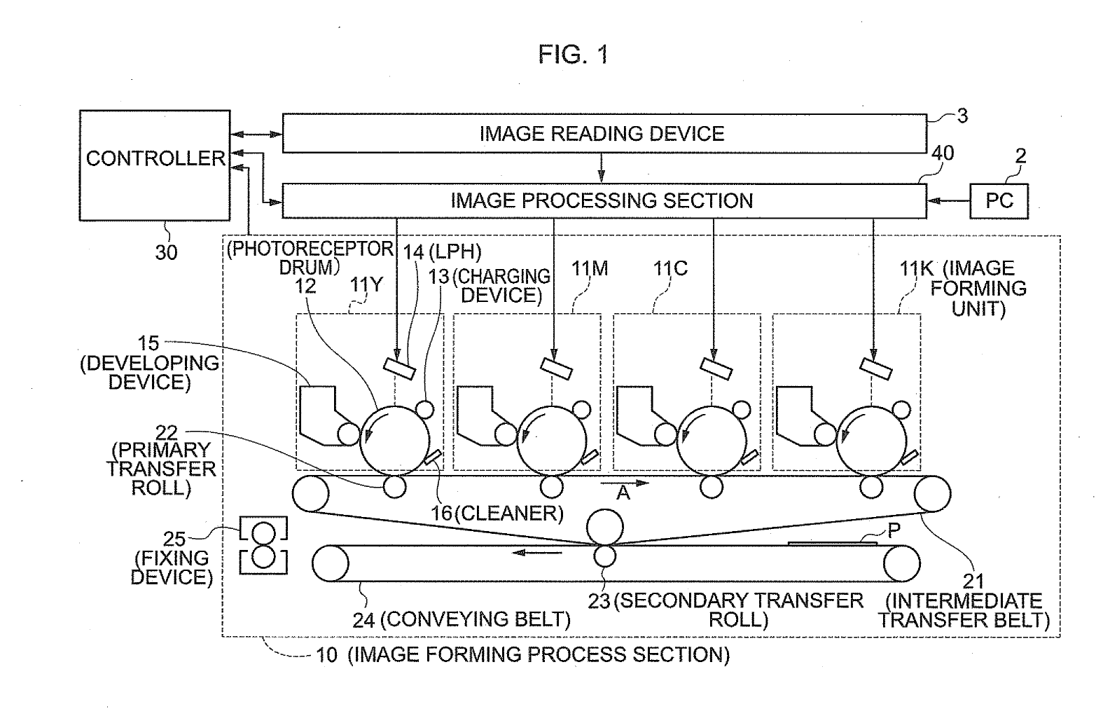

FIG. 1 is a schematic diagram showing an example of a configuration of an image forming apparatus according to an exemplary embodiment of the present invention. This image forming apparatus is a so-called tandem digital color printer, provided with: an image forming process section 10, serving as an image forming section, in which image forming is performed corresponding to image data of each of the colors; a controller 30 that controls the operation of the image forming apparatus; and an image processing section 40, connected to an image reading device 3 and, for example, to an external device, such as, for example, a personal computer (PC) 2 or the like, the image processing section 40 subjecting image data received from these external devices to specific image processing.

The image forming process section 10 includes four image forming units 11Y, 11M, 11C, 11K that are disposed parallel to each other at uniform intervals. The image forming units 11Y, 11M, 11C, 11K each form toner images of yellow (Y), magenta (M), cyan (C) and black (K), respectively. Where appropriate the image forming units 11Y, 11M, 11C, 11K are referred to collectively as the “image forming units 11”.

Each of the image forming units 11 includes: a photoreceptor drum 12, serving as an image holding body, for forming an electrostatic latent image on and for holding a toner image; a charging device 13 that uniformly charges the surface of the photoreceptor drum 12 to a specific electrical potential; a LED print head (LPH) 14, serving as an exposing device, that exposes the photoreceptor drum 12 that has been charged by the charging device 13; a developing device 15 that develops the electrostatic latent image obtained with the LPH 14; and a cleaner 16 that cleans the surface of the photoreceptor drum 12 after transfer.

The LPH 14 is an elongated print head of substantially the same length as the axial direction length of the photoreceptor drum 12. The LPH 14 is disposed at the periphery of the photoreceptor drum 12 facing such that the length direction of the LPH 14 is along the axial direction of the photoreceptor drum 12. In the present exemplary embodiment, plural LEDs are disposed along the length direction of the LPH 14 in an array. Plural hologram elements, corresponding to the plural LEDs, are disposed in an array above the LED array.

As described below, the length of the operating distance of the LPH 14 equipped with hologram element array is long, and the LPH 14 is disposed at a separation distance of several cm from the surface of the respective photoreceptor drum 12. Due thereto, the occupied width of the LPH 14 along the circumferential direction of the photoreceptor drum 12 is small, and crowding around the periphery of the photoreceptor drum 12 is alleviated.

The image forming process section 10 includes: an intermediate transfer belt 21, onto which toner images, of each of the colors formed on the respective photoreceptor drums 12 of the image forming units 11, are multi-transferred; primary transfer rolls 22 that transfer (primary transfer) the toner images of each of the colors of the respective image forming units 11 in sequence onto the intermediate transfer belt 21; a secondary transfer roll 23 that transfers in one action (secondary transfers) the superimposed toner images, which have been transferred onto the intermediate transfer belt 21, onto paper P, serving as a recording medium; and a fixing device 25 that fixes the secondary transferred images to the paper P.

Explanation follows regarding operation of the above image forming apparatus. First, the image forming process section 10 performs image forming operation, based on a control signal, such as, for example, a synchronization signal supplied from the controller 30. In so doing, image data input from the image reading device 3 or the PC 2 is subjected to image processing by the image processing section 40, and then supplied to each of the image forming units 11 through an interface.

For example, in the image forming unit 11Y, the surface of the photoreceptor drum 12, uniformly charged to a specific electrical potential by the charging device 13, is exposed by the LPH 14 emitting light based on the image data obtained from the image processing section 40, and electrostatic latent images are formed on the photoreceptor drum 12. Namely, the surface of the photoreceptor drum 12 is fast scanned by each of the LEDs of the LPH 14 emitting light according to the image data, and slow scanned by rotating the photoreceptor drum 12, thereby forming an electrostatic latent image on the photoreceptor drum 12. The electrostatic latent image that has been formed is developed by the developing device 15, forming a yellow toner image on the photoreceptor drum 12. Toner images of magenta, cyan, and black are formed in a similar manner in the image forming units 11M, 11C, 11K, respectively.

Each of the color toner images formed on the respective image forming unit 11 is transferred (primary transferred) onto the intermediate transfer belt 21 that is rotating in the arrow A direction of FIG. 1, by sequential electrostatic attraction using the primary transfer rolls 22. Superimposed toner images are formed on the intermediate transfer belt 21. The superimposed toner images are conveyed, along with movement of the intermediate transfer belt 21, to a region where the secondary transfer roll 23 is disposed (a secondary transfer portion). When the superimposed toner images have been conveyed to the secondary transfer portion, paper P is fed into the secondary transfer portion with a timing that matches conveying of the toner images to the secondary transfer portion.

Then, the superimposed toner images are electrostatically transferred (secondary transferred) in one action onto the conveyed paper P by a transfer field formed by the secondary transfer roll 23 at the secondary transfer portion. The paper P, onto which the superimposed toner images have been electrostatically transferred, separates from the intermediate transfer belt 21, and is conveyed by a conveying belt 24 to the fixing device 25. The unfixed toner images on the paper P that has been conveyed to the fixing device 25 are imparted with heat and pressure in fixing processing by the fixing device 25, and fixed onto the paper P. Then, the paper P formed with the fixed image, is discharged to a discharge section of the image forming apparatus, provided with a discharge tray (not shown in the figures).

LED Print Head (LPH)

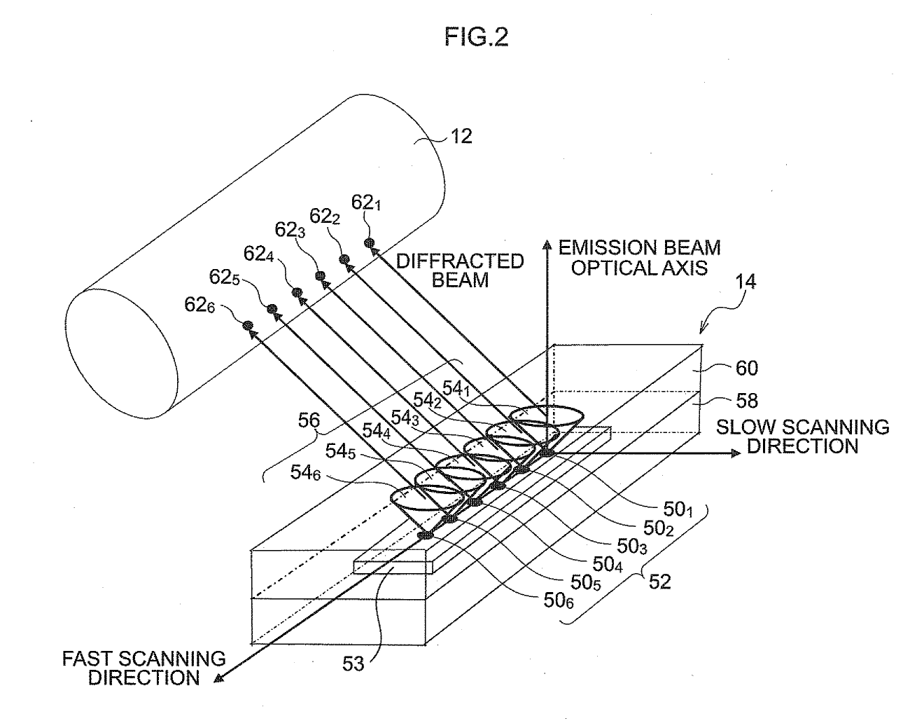

FIG. 2 is a schematic perspective view showing an example of a configuration of a LED print head according to an exemplary embodiment of the present invention. As shown in FIG. 2, the LED print head (LPH 14) includes: an LED array 52 provided with plural LEDs 50; a hologram element array 56 provided with plural hologram elements 54, corresponding one-to-one with the plural LEDs 50. In the example shown in FIG. 2, the LED array 52 is provided with six individual LEDs 50₁ to 50₆, and the hologram element array 56 is provided with six individual hologram elements 54₁ to 54₆. When there is no need to discriminate between these elements, the LEDs 50₁ to 50₆ are referred to collectively as the “LEDs 50”, and the hologram elements 54₁ to 54₆ are referred to collectively as the “hologram elements 54”.

The plural LEDs 50 are each arrayed on an LED chip 53. The LED chip 53 arrayed with the plural LEDs 50 is packaged, along with drive circuits (not shown in the figures) for driving each of the LEDs 50, to an elongated LED substrate 58. The LED chip 53 is aligned such that the plural LEDs 50 are in a row along the fast scanning direction, and placed on the LED substrate 58. Due thereto, the LEDs 50 are respectively arrayed along a direction that is parallel to the axial direction of the photoreceptor drum 12.

The array direction of the LEDs 50 is the “fast scanning direction”. Each of the LEDs 50 is arrayed such that the interval (LED pitch) in the fast scanning direction between two adjacent LEDs 50 is a constant interval. Slow scanning is performed by rotating the photoreceptor drum 12, with a direction orthogonal to the “fast scanning direction” indicated as the “slow scanning direction”. In the following, the positions where the LEDs 50 are disposed are referred to as “light emitting points” where appropriate.

As the LED array 52, for example, various embodiments of LED array may be employed, such as an LED array with plural LEDs packaged in chip units on a substrate. In an array of plural individual LED chips, each arrayed with plural LEDs, the plural LED chips may be disposed in a straight line, or may be disposed in a staggered formation. Two or more individual LED chips may also be disposed in the slow scanning direction. FIG. 2 is merely a schematic representation of the LED array 52, having plural LEDs 50 arrayed in a single dimension on a single LED chip 53.

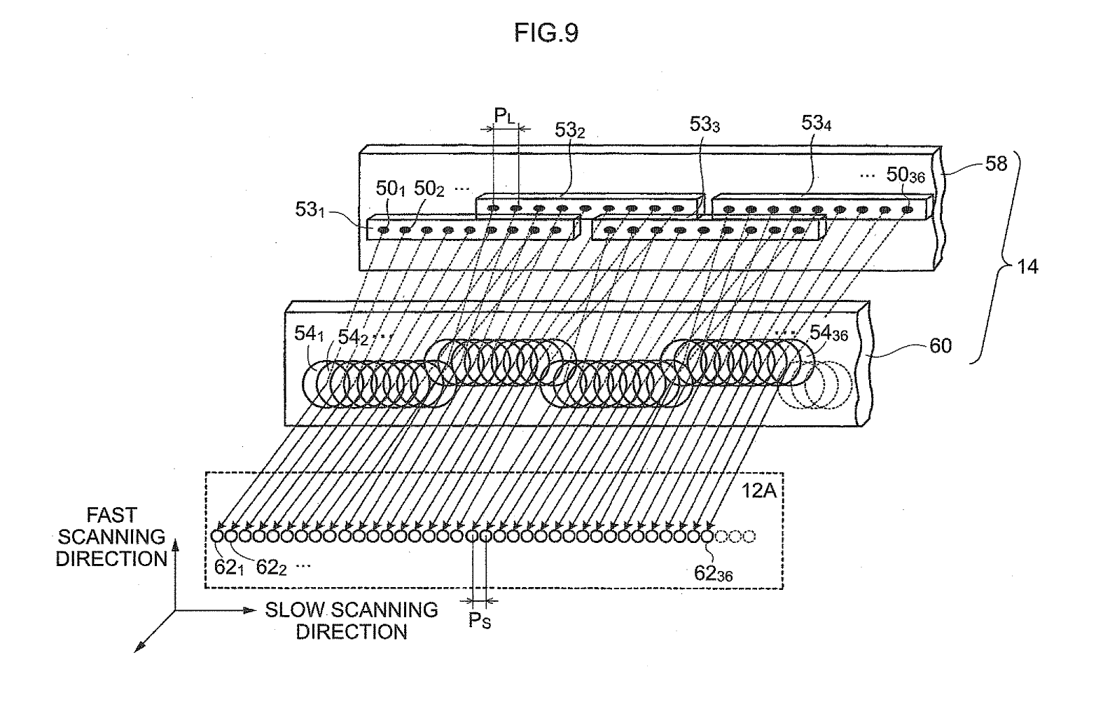

As described below, in the present exemplary embodiment, plural of the LED chips 53 are arrayed in a staggered formation in the LED array 52 (see FIG. 9). Namely, plural LED chips 53 are disposed so as to form one row along the fast scanning direction, and also disposed in a second row, shifted by a specific interval in the slow scanning direction. Even though split across the plural LED chips 53, the plural LEDs 50 within a single LED chip 53 are respectively arrayed such that the interval between adjacent two LEDs 50 in the fast scanning direction is a uniform interval.

As the LED array 52, an SLED chip (not shown in the figures) arrayed with plural Self-scanning LEDs (SLEDs) may be employed, or an SLED array may be configured with plural individual SLED chips, such that the LEDs are arrayed in a row along the fast scanning direction. In an SLED array, switching ON and OFF is performed with two signal lines, and each of the SLEDs is selectively caused to emit light with a common data line. By employing such an SLED array, a fewer number of wiring lines are required on the LED substrate 58.

A hologram recording layer 60 is formed on the LED substrate 58, so as to cover the LED chip(s) 53 described above. The hologram element array 56 is formed within the hologram recording layer 60 formed on the LED substrate 58. As described below, close bonding of the LED substrate 58 and the hologram recording layer 60 is not required, and configuration may be made with a specific separation therebetween, and, for example, an air layer or transparent resin layer interposed therebetween. For example, the hologram recording layer 60 may be positioned so as to be separated from the LED substrate 58 at a specific height, and be protected by a protection member, not shown in the figures.

In the hologram recording layer 60, the plural hologram elements 54₁ to 54₆ are formed along the fast scanning direction so as to correspond with each of the respective plural LEDs 50₁ to 50₆. The respective hologram elements 54 are arrayed such that the separation between two adjacent hologram elements 54 in the fast scanning direction is substantially the same separation as the separation distance between LEDs 50 in the fast scanning direction, described above. Namely, the hologram elements 54 are formed with relatively large diameters such that two adjacent hologram elements 54 overlap with each other. Two adjacent holograms may also have different shapes from each other.

Note that the hologram recording layer 60 is formed from a polymer material capable of permanently recording and holding a hologram. A so-called photopolymer may be employed as such a polymer material. A photopolymer records a hologram by utilizing the change in refractive index due to polymerization of a photo-polymerizable monomer.

When the LEDs 50 are caused to emit light, light emitted from the LEDs 50 (incoherent light) spreads out from the light emitting point to the hologram diameter along an optical path of diffused light. Due to the emitted light of the LEDs 50, substantially the same state is achieved as when the reference beam was illuminated onto the hologram elements 54. As shown in FIG. 2, in the LPH 14 equipped with the LED array 52 and the hologram element array 56, each beam emitted from the respective LED of the six individual LEDs 50₁ to 50₆ is incident to the corresponding hologram elements 54₁ to 54₆. The hologram elements 54₁ to 54₆ diffract the incident light and generate diffracted beams. Each of the respective diffracted beams generated by the respective hologram elements 54₁ to 54₆ does not follow the optical path of the diffused light, and is emitted with an optical axis in a direction that forms an angle of 0 degrees to the emission beam optical axis, converging light towards the photoreceptor drum 12.

Each of the emitted diffracted beams converges towards the photoreceptor drum 12, and an image is formed on the surface of the photoreceptor drum 12 that is disposed at the focal plane some few cm away. Namely, each of the plural hologram elements 54 functions as an optical member that diffracts the light emitted from the corresponding LED 50, converges the light, and forms an image on the surface of the photoreceptor drum 12. Very small diameter spots 62₁ to 62₆ are formed by the respective diffracted beams on the surface of the photoreceptor drum 12, so as to form an array of a single row in the fast scanning direction. In other words, the photoreceptor drum 12 is fast scanned by the LPH 14. When there is no need to discriminate between the individual spots 62₁ to 62₆ they are referred to collectively as spots 62.

Shape of Hologram Elements

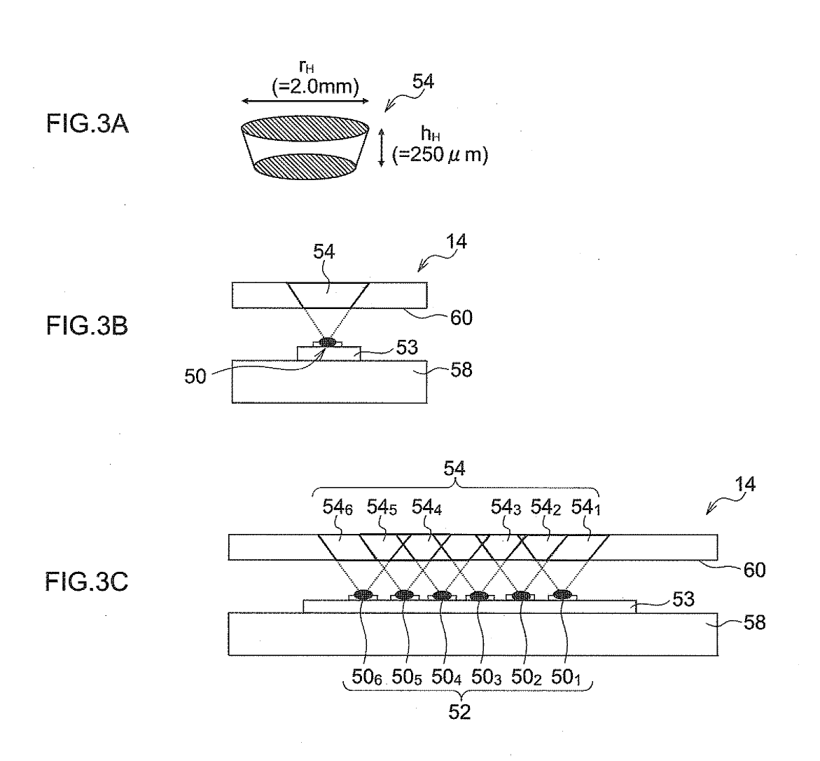

FIG. 3A is a perspective view showing schematically the shape of the hologram elements, FIG. 3B is a cross-section taken along the slow scanning direction of the LED print head, and FIG. 3C is a cross-section taken along the fast scanning direction of the LED print head.

As shown in FIG. 3A, each of the hologram elements 54 is a volume hologram, generally referred to as a thick hologram. As described above, the hologram elements have high incident angle selectivity and wavelength selectivity, controlling the diffracted beam emission angle (diffraction angle) with high precision, and forming very small diameter spots with a sharp outline. The greater the thickness of the hologram, the higher the precision obtained in the diffraction angle.

As shown in FIG. 3A and FIG. 3B, each of the hologram elements 54 forms a truncated circular cone shape with the front face of the hologram recording layer 60 as the bottom face of the truncated circular cone, converging towards the LED 50 side. In this example, explanation is of a case of truncated circular cone shaped hologram elements, however the hologram elements are not limited to such shapes. For example, the hologram elements may, for example, be shaped as circular cones, elliptical cones, truncated elliptical cones or the like. The diameter of the circular cone shaped hologram elements 54 is largest at the bottom face. The diameter of the circular bottom face is referred to as the “hologram diameter r_{H}”.

Each of the hologram elements 54 has a “hologram diameter r_{H}” larger than the separation of the LEDs 50 in the fast scanning direction. For example, with a separation of the LEDs 50 in the fast scanning direction of 30 μm, the hologram diameter r_{H} is 2 mm, and the hologram thickness h_{H} is 250 μm. Consequently, as shown in FIG. 2 and FIG. 3C, two mutually adjacent hologram elements 54 are formed so as to overlap with each other to a large extent. The plural hologram elements 54 are, for example, multiplex recorded by spherical wave shift multiplexing.

Each of plural LEDs 50 is disposed on the LED substrate 58 with its light emitting face facing towards the hologram recording layer 60 side, so as to emit light towards the side of the corresponding hologram element 54. The “emission beam optical axis” of the LEDs 50 passes through near to the center (for example, the axis of symmetry of the truncated circular cone) of the corresponding hologram elements 54, in a direction orthogonal to the LED substrate 58. As illustrated, the emission beam optical axes are orthogonal to both the fast scanning direction and the slow scanning direction.

While not shown in the figures, the LPHs 14 are each held by a retaining member such as, for example, a housing, a holder or the like, such that the diffracted beams generated by the hologram elements 54 are emitted towards the photoreceptor drum 12, attached at a specific position inside the respective image forming unit 11 shown in FIG. 1. Configuration may be made such that the LPH 14 is movable in the optical axis direction of the diffracted beams by employing an adjuster such as, for example, an adjustment screw (not shown in the figures). In such cases, adjustment is made with the adjuster described above such that the image forming position (focal plane) of the hologram elements 54 is positioned on the surface of the photoreceptor drum 12. Configuration may also be made with a protection layer, such as, for example, a cover glass, transparent resin, or the like, formed over the hologram recording layer 60. The adherence of dust is prevented by such a protection layer.

Hologram Recording Method

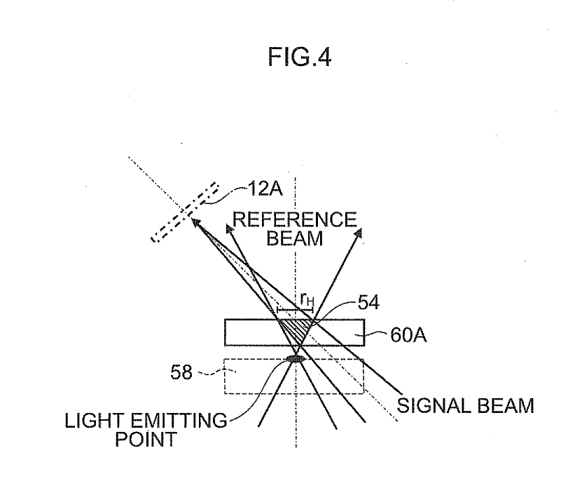

Next, explanation follows regarding a recording method of a hologram. FIG. 4 is a diagram showing an element formed by the hologram element 54 in the hologram recording layer, namely, an element of a hologram recorded in the hologram recording layer. The photoreceptor drum 12 is omitted from the figure, and only a surface 12A, which is the image forming plane, is illustrated. A hologram recording layer 60A is a recording layer prior to forming the hologram element 54, with the suffix A appended thereto in order to differentiate from the hologram recording layer 60 that has been formed with the hologram element 54.

As shown in FIG. 4, coherent light passes along an optical path of the diffracted beam for forming an image on the surface 12A, and is illuminated onto the hologram recording layer 60A as a signal beam. At the same time, coherent light passing along the optical path of diffused light, spreading out from the light emitting point to the specific hologram diameter r_{H} while passing through the hologram recording layer 60A, is illuminated onto the hologram recording layer 60A as reference beam. A laser light source, such as, for example, a semiconductor laser or the like, is employed for the illumination of the coherent light.

The signal beam and the reference beam are illuminated onto the hologram recording layer 60A from the same side (the side at which the LED substrate 58 is disposed). An interference fringe (intensity distribution) obtained by interference of the signal beam and the reference beam is recorded across the thickness direction of the hologram recording layer 60A. The hologram recording layer 60 formed with the transmission hologram element 54 is thereby obtained. The hologram element 54 is a volume hologram in which an intensity distribution of an interference fringe is recorded in both the plane direction and the thickness direction. The LPH 14 is produced by attaching the hologram recording layer 60 above the LED substrate 58 packaged with the LED array 52.

The signal beam and the reference beam may be illuminated from the opposite side to the direction described above, and the holograms formed, after attaching the hologram recording layer 60A above the LED substrate 58 packaged with the LED array 52. In such cases, the hologram recording layer 60 formed with the transmission hologram elements 54 can also be obtained.

Hologram Regeneration Method

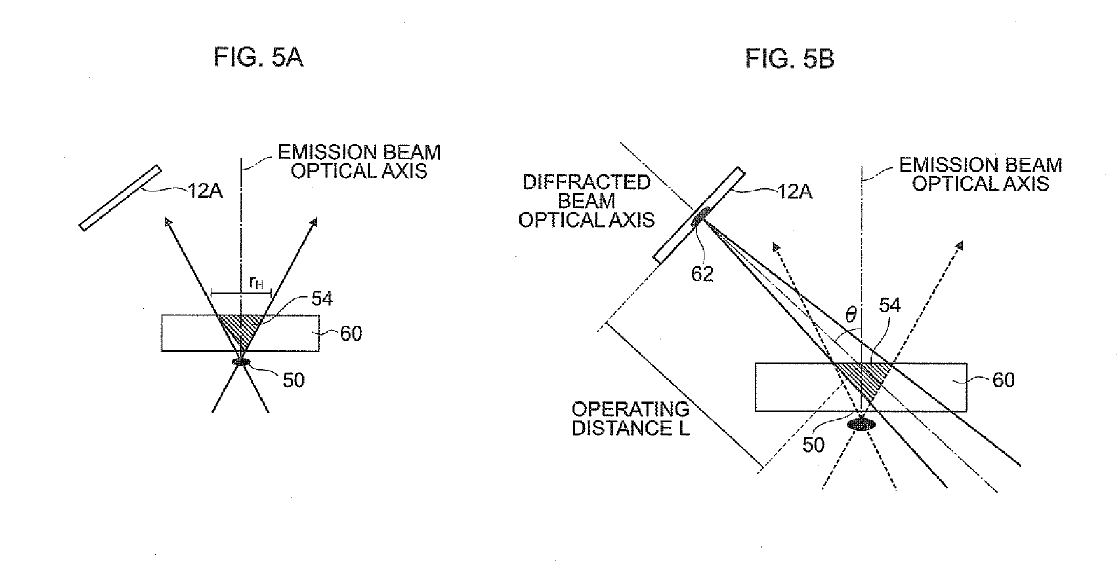

Next, explanation follows regarding a regeneration method of the holograms. FIG. 5A and FIG. 5B are diagrams showing an element in which a diffracted beam is generated from a hologram element, namely an element in which a hologram recorded in a hologram recording layer is illuminated, generating a diffracted beam. As shown in FIG. 5A, when the LED 50 emits light, the light emitted from the LED 50 passes along the optical path of diffused light, spreading out from the light emitting point to the hologram diameter r_{H}. Due to the emitted light of the LED 50, a substantially similar state is achieved to that when the reference beam was illuminated onto the hologram element 54.

As shown in FIG. 5B, due to illumination of the reference beam, shown by dotted lines, the same beam as the signal beam, shown by the solid lines, is regenerated from the hologram element 54, and emitted as the diffracted beam. The emitted diffracted beam converges, forming an image on the surface 12A of the photoreceptor drum 12 at the operating distance of a few cm. The spots 62 are formed on the surface 12A. FIG. 5B is a schematic illustration of the surface 12A, however due to the hologram diameter r_{H} being a few mm in size, and the operating distance L being a few cm, the surface 12A is actually at a considerably separated position. Therefore, the hologram element 54 is not actually of the conical cone shape shown, but rather is of a truncated circular cone shape like that shown in FIG. 3A.

As shown in FIG. 2, six individual spots 62₁ to 62₆ are formed in a row along the fast scanning direction on the photoreceptor drum 12, corresponding to the LEDs 50₁ to 50₆ of the LED array 52. The six individual spots 62₁ to 62₆ are focused spots where images of the diffracted beams of the hologram elements 54₁ to 54₆ are formed. In particular, the volume hologram has high incident angle selectivity and wavelength selectivity, and a high diffraction rate is obtained. Accordingly, the background noise is reduced, the signal beam is regenerated with high precision, and very small diameter spots (focused beam spots) with sharp outlines are formed on the surface 12A.

LED Array and Spot Array

In FIG. 2 an example is schematically shown of six individual LEDs 50₁ to 50₆ arrayed in a single row, however in an actual image forming apparatus, several thousand individual LEDs 50 are arrayed according to the resolution in the fast scanning direction. For example, in explanation of an example of an SLED array, 29 individual SLED chips, each arrayed with 256 individual SLEDs, are disposed in a straight line, configuring an SLED array with 7424 individual SLEDs.

In a conventional LPH utilizing a lens array, such as, for example, SELFOC (registered trademark) lenses or the like, in order to form a right side up image of the same size on a photoreceptor drum, SLEDs are arrayed with a separation corresponding to the resolution (spot pitch) of the image forming apparatus. For example, in an image forming apparatus with a resolution of 1200 spots per inch (spi), the 7424 individual SLEDs are arrayed at a separation of 21 μm. Corresponding to these 7424 individual SLEDs, 7424 individual spots 62 are formed on the photoreceptor drum 12, in a row along the fast scanning direction with a separation of 21 μm.

In the present exemplary embodiment, the LPH 14 is equipped with the hologram element array 56 formed with the plural hologram elements 54 corresponding to each of the respective plural LED 50s, Even though the “LED pitch” of the LEDs 50 configuring the LED array 52 is determined irrespectively to the “spot pitch” of the row of spots 62, the spots 62 are formed at the desired positions on the surface 12A (namely at the desired spot pitch) by the hologram elements 54 converging the diffracted beams in the desired direction. The degrees of freedom in design of the LED array 52 are thereby increased.

Having a wider separation of the plural light emitting elements in the fast scanning direction than the separation of the focused beam spots in the fast scanning direction enables the overlap of plural hologram elements to be reduced, while maintaining a high resolution. Due thereto, crosstalk between overlapping hologram elements can be reduced. The diffraction efficiency can be raised by lowering the degree of multiplexing of the hologram elements, and an increase in the light intensity at the exposure plane can be achieved.

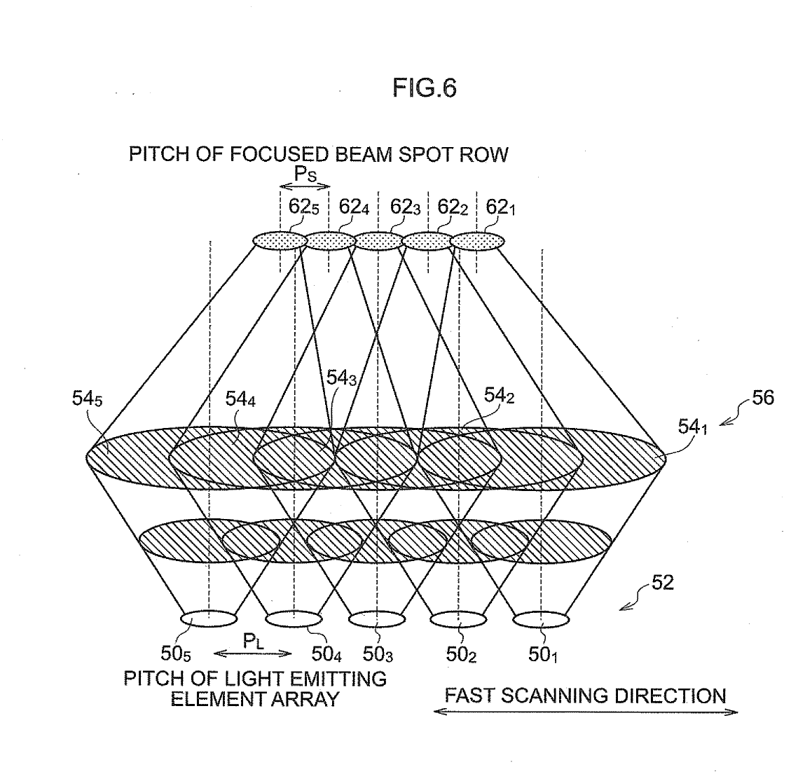

FIG. 6 is a diagram showing elements regenerating in a case where the LED pitch is greater than the spot pitch. As shown in FIG. 6, the LED pitch of the LEDs 50₁ to 50₅ configuring the LED array 52 is “P_{L}”, and the spot pitch of the spots 62₁ to 62₅ corresponding to the respective LEDs 50₁ to 50₅ is “P_{S}”. The LED pitch P_{L} is greater than the spot pitch P_{S}. Namely, the separation of the LEDs 50 in the fast scanning direction is wider than the separation of the spots 62 in the fast scanning direction.

In FIG. 6, only the front face (diagonally shaded portions) and the back face (diagonally shaded portions) of the hologram elements 54 are shown, however the hologram elements 54 are truncated circular cone shaped volume holograms, multiplex recorded so as to overlap to a large extent with each other. Consequently, by fixing the spot pitch P_{S} and making the LED pitch P_{L} greater than the spot pitch P_{S}, overlapping of the hologram elements 54 is alleviated to a certain extent, and crosstalk between plural hologram elements 54 is reduced while maintaining a high degree of resolution. Accordingly, the diffraction efficiency of the hologram elements 54 is raised, and the light intensity at the surface 12A of the photoreceptor drum 12, this being the exposure plane, is increased.

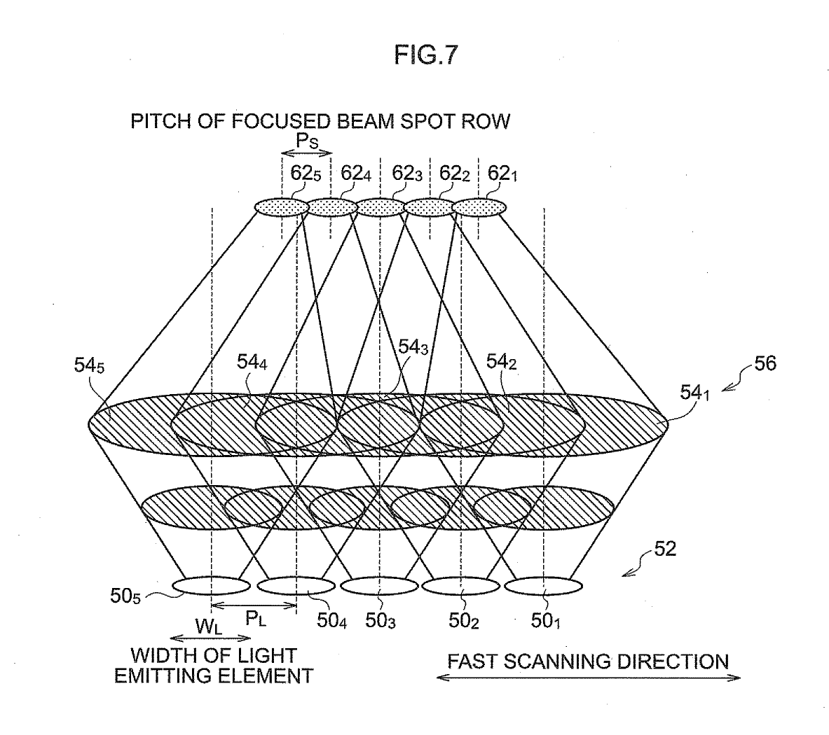

FIG. 7 is a diagram showing elements regenerating in a case where both the LED pitch and the LED diameter are greater than the spot pitch. As shown in FIG. 7, the separation of the LEDs 50 in the fast scanning direction is wider than the separation of the spots 62 in the fast scanning direction. Namely, the LED pitch P_{L} of the LED array 52 is greater than the spot pitch P_{S}. The diameter of the light emitting region of the LEDs 50 (LED diameter), “W_{L}”, is greater than the spot pitch P_{S}. Note that in FIG. 7, the LED diameter W_{L} is marked as the “width of light emitting element”.

When the LED diameter “W_{L}” is increased, the surface area of the light emitting region is increased, and the amount of light also increases. However, if the LED pitch P_{L} and the spot pitch P_{S} are left unaltered, crosstalk between plural hologram elements 54 increases. In contrast thereto, by making the LED pitch P_{L} greater than the spot pitch P_{S}, crosstalk between plural hologram elements 54 is suppressed. Consequently, when the LED pitch P_{L} is made greater than the spot pitch P_{S} and also the LED diameter W_{L} is made greater than the spot pitch P_{S}, in addition to increasing the amount of light by raising the diffraction efficiency, the amount of light is also further increased by increasing the surface area of the light emitting region.

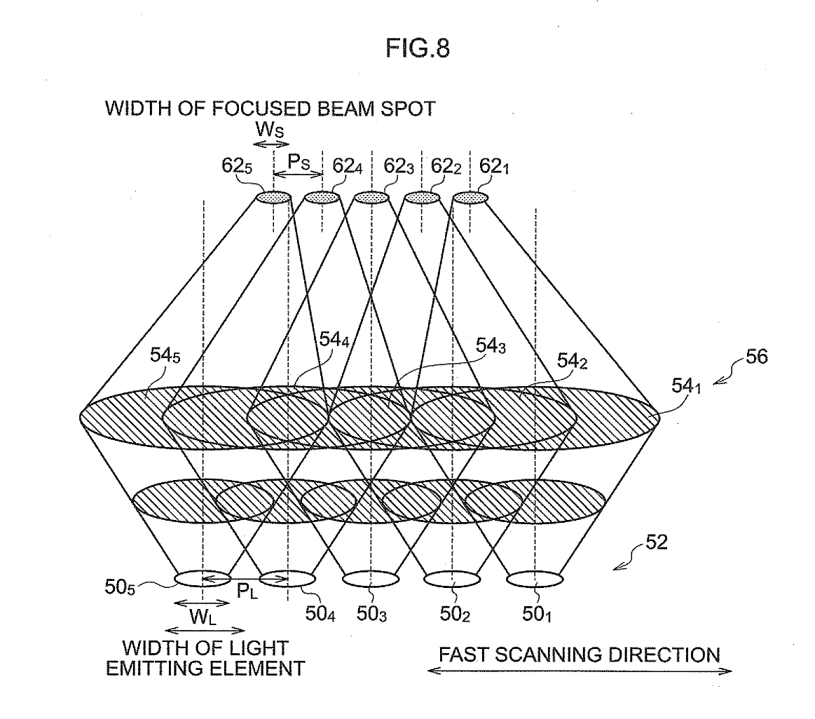

FIG. 8 is a diagram showing elements regenerating in a case where the LED pitch is greater than the spot pitch and the LED diameter is greater than the spot diameter. As shown in FIG. 8, the separation of the LEDs 50 in the fast scanning direction is greater than the separation of the spots 62 in the fast scanning direction. Namely, the LED pitch P_{L} of the LED array 52 is greater than the spot pitch P_{S}. The LED diameter (LED diameter) “W_{L}” of the light emitting regions of the LEDs 50 in the fast scanning direction is also greater than the diameter (spot diameter) of the spots 62 in the fast scanning direction. Namely, a spot diameter W_{S} of the spots 62 is smaller than the LED diameter W_{L} of the LEDs 50. In FIG. 8, the “spot diameter W_{S}” is marked as “width of focused beam spot”.

As the LED pitch P_{L} increases, the pitch of the plural hologram elements 54 configuring the hologram element array 56 also gets greater. Accordingly, by increasing the hologram diameter r_{H} and making the hologram thickness h_{H} thicker, the precision of the diffraction angle of the hologram element 54 is increased, and the spot diameter W_{S} of the spots 62 is made smaller. By making an even smaller finer diameter for the spots 62, the resolution is further raised.

Specific Configuration of LPH

Next, explanation follows regarding a specific configuration by a LPH employing SLED chips. As explained above, in an actual image forming apparatus a large number of SLEDs are arrayed with a narrow pitch according to the resolution, such as, for example, in an image forming apparatus of 1200 spi resolution, an SLED array is configured with 7424 individual SLEDs, using 29 individual SLED chips arrayed in a straight line, with each SLED chip arrayed with 256 individual SLEDs at a separation of 21 μm.

FIG. 9 is an exploded perspective view showing an example of part of a configuration of an LED print head formed by a hologram element array corresponding to an SLED array. The exploded perspective view of FIG. 9 is a more specific diagram of the configuration of LPH schematically shown in FIG. 2, and is close to a configuration employed in an actual image forming apparatus. Note that where “SLED” is used rather than “LED” the same reference number as the LEDs 50 is used, and reference is made to “SLED 50”. The SLED chip is also allocated to the same reference number and is referred to as “SLED chip 53”.

As described above, in the LPH 14 of an actual image forming apparatus, several thousand individual SLEDs are arrayed according to the resolution in the fast scanning direction. The LPH 14 shown in FIG. 9, is equipped with the LED substrate 58, packaged with the LED array 52 and the hologram recording layer 60 formed with the plural hologram elements 54. The LED array 52 is an SLED array in which plural SLED chips 53 are disposed in two rows in a staggered formation.

In the exploded perspective view shown in FIG. 9, as a portion of the LPH 14 close to an actual configuration, elements are shown with four individual SLED chips 53₁ to 53₄ arrayed in two rows in a staggered formation. The two individual SLED chips 53₁ and 53₃ are arrayed in the first row, and the two individual SLED chips 53₂ and 53₄ are arrayed in the second row.

Each of the SLED chips 53₁ to 53₄ is a one dimensional array of nine individual SLEDs 50, disposed with a LED pitch “P_{L}”. Accordingly, in the example shown in FIG. 9, a total of 36 individual SLEDs 50 (SLEDs 50₁ to 50₃₆) are illustrated. Each of the four individual SLED chips 53₁ to 53₄ is disposed such that the array direction of the SLEDs 50 is facing along the fast scanning direction.

Corresponding to each of the 36 individual SLEDs 50, 36 individual hologram elements 54₁ to 54₃₆ are formed with predesigned positions and shapes. Due thereto, 36 individual spots 62₁ to 62₃₅ are formed on the surface 12A of the photoreceptor drum 12, corresponding to the respective 36 individual SLEDs 50₁ to 50₃₆, in a single row along the fast scanning direction with a specific spot pitch “P_{S}”. In an actual image forming apparatus, there are several thousand individual spots 62 formed, corresponding to several thousand individual SLEDs 50.

In the present exemplary embodiment, as shown in FIG. 6, the LED pitch P_{L} is greater than the spot pitch P_{S}. Namely, the separation of the LEDs 50 in the fast scanning direction is wider than the separation of the spots 62 in the fast scanning direction. In this example, the LED pitch P_{L} is twice the spot pitch P_{S} or greater. If the LED pitch P_{L} is simply made greater than the spot pitch P_{S}, the length of the LPH 14 in the fast scanning direction gets longer.

In the present exemplary embodiment, the length of the LPH 14 in the fast scanning direction is made substantially the same length as that of the row of spots 62 formed on the surface 12A of the photoreceptor drum 12 by splitting plural SLEDs 50 configuring the LED array 52 into plural units and arraying in a two dimensional pattern, such that the four individual SLED chips 53₁ to 53₄, each arrayed one dimensionally with nine SLEDs 50, are arrayed in a staggered formation. In comparison to a case where the SLEDs 50 are disposed in a single row, the diffraction angle of the hologram element 54 is smaller, and the positional precision of the corresponding spots 62 formed is increased.

In the example shown in FIG. 9 too, the LED diameter W_{L} of the SLEDs 50 may also be made greater than the spot pitch P_{S} of the spots 62 as shown in FIG. 7. Furthermore, the spot diameter W_{S} of the spots 62 may be made smaller than the LED diameter W_{L} of the SLEDs 50, as shown in FIG. 8.

### Other Modified Examples

As described above, explanation has been given of examples of LED print heads provided with plural LEDs, however other light emitting elements may be employed in place of LEDs, such as, for example, electroluminescent (EL) elements, laser diodes (LD) or the like. By designing the hologram elements according to the characteristics of the light emitting elements, and by preventing unwanted exposure by incoherent light, even in cases where LEDs and ELs, emitting incoherent light, are employed as the light emitting elements, very small diameter spots with a sharp outline are formed, similarly to when LDs emitting coherent light are employed as the light emitting elements.

As described above, explanation has been given of an example in which plural hologram elements are multiplex recorded by spherical wave shift multiplexing, however another multiplexing method may be employed to multiplex record plural hologram elements, as long as the multiplexing method is one capable of obtaining the desired diffracted beams. Configuration may also be made in which plural types of multiplexing method are combined. Such other multiplexing methods include, for example, angle multiplex recording in which the incident angle of the reference beam is changed during recording, wavelength multiplex recording in which the wavelength of the reference beam is changed during recording, and phase shift multiplex recording in which the phase of the reference beam is changed during recording. Separate diffracted beams are regenerated without crosstalk from such multiplex recorded plural holograms.

Furthermore, as described above, explanation has been given of an example in which the image forming apparatus is a tandem digital color printer, and the photoreceptor drum of each image forming unit is exposed using an LED print head as an exposing device. However there is no particular limitation to the above application example, and application may be made to any image forming apparatus that forms an image by imagewise exposure of a photosensitive image recording medium using an exposing device. For example, the image forming apparatus is not limited to a digital color printer using an electrophotographic method. The exposing device of the present invention may be installed in a silver-halide image forming apparatus, in a writing apparatus that writes light onto electronic paper or the like. The photosensitive image recording medium is also not limited to a photoreceptor drum. The exposing device described in the above application may also be applied to light exposure of, for example, a sheet form photoreceptor or a photographic light sensitive material, photoresist, photopolymer or the like.

What is claimed is:

1. An exposing device comprising:
a light emitting element array of a plurality of light emitting elements arrayed in a row with a first separation along a predetermined direction; and
a hologram element array in which a plurality of hologram elements are multiplex recorded in a recording layer disposed above the light emitting element array, the plurality of hologram elements corresponding to each of the plurality of light emitting elements such that diffracted beams of light emitted from the plurality of light emitting elements are converged to form focused beam spots in a row along the predetermined direction with a second separation smaller than the first separation at an surface to be exposed.

2. The exposing device of claim 1, wherein each of the plurality of light emitting elements are arrayed such that a length of light emitting region of each of the plurality of light emitting elements in the predetermined direction is longer than the second separation.

3. The exposing device of claim 1, wherein the plurality of hologram elements respectively converge the diffracted beams onto the exposure face such that a length of the light emitting region in the predetermined direction is longer than the diameter of the focused beam spots in the predetermined direction.

4. The exposing device of claim 1, wherein the plurality of light emitting elements are split into a plurality of units and arrayed in a two dimensional formation.

5. An image forming apparatus comprising:
the exposing device of claim 1; and
a photoreceptor disposed at a operating distance from the exposing device, the photoreceptor being written with an image according to image data, by fast scanning in which the focused beam spots from the exposing device are in a row along the predetermined direction.
